(19) United States
(12) Patent Application Publication
(10) Pub. No.: US 2019/0081321 A1
(43) Pub. Date: Mar. 14, 2019

(54) ELECTRODE COMPOSITION INCLUDING AT LEAST TWO ELECTRODE ACTIVE MATERIALS HAVING DIFFERENT CRUSHING STRENGTH FROM EACH OTHER AND LITHIUM SECONDARY BATTERY CONTAINING THE SAME

(71) Applicants: Hyundai Motor Company, Seoul (KR); Kia Motors Corporation, Seoul (KR)

(72) Inventors: Pil Gun Oh, Seoul (KR); Sang Heon Lee, Yongin (KR); O Min Kwon, Busan (KR); Hong Seok Min, Yongin (KR); Yong Sub Yoon, Seoul (KR)

(21) Appl. No.: 15/830,664

(22) Filed: Dec. 4, 2017

(30) Foreign Application Priority Data
Sep. 12, 2017 (KR) 10-2017-0116440

(51) Int. Cl. H01M 4/36; H01M 10/0525; H01M 4/62; H01M 4/583; H01M 4/485; H01M 4/50; H01M 4/52; H01M 4/38

(52) U.S. Cl. CPC H01M 4/366; H01M 10/0525; H01M 4/623; H01M 4/583; H01M 4/485; H01M 2220/30; H01M 4/52; H01M 4/387; H01M 4/386; H01M 4/382; H01M 2220/20; H01M 4/50

(57) ABSTRACT

An electrode composition includes at least two electrode active materials having different crushing strengths and particle sizes. An electrode includes at least two electrode active materials having different crushing strengths and particle sizes, and the at least two electrode active materials include a first active material and a second active material, the first active material having a higher crushing strength than that of the second active material, and the first active material having a larger particle size than that of the second active material. A lithium secondary battery includes an anode which is an electrode including at least two electrode active materials having different crushing strengths and particle sizes.

### CROSS-REFERENCE TO RELATED APPLICATION

This application claims under 35 U.S.C. § 119(a) the benefit of priority to Korean Patent Application No. 10-2017-0116440 filed Sep. 12, 2017, the entire contents of which are incorporated by reference as if fully set forth herein.

### BACKGROUND

### (a) Technical Field

The present disclosure relates generally to an electrode compositions and, more particularly, to an electrode composition including at least two electrode active materials having different crushing strengths and particle sizes and a lithium secondary battery containing the same.

### (b) Background Art

Secondary batteries are widely used across a spectrum of applications from large devices such as vehicles and power storage systems to small devices such as mobile phones, camcorders, and laptops. As the application field of the secondary battery expands, the demand for improved safety and high performance of the battery increases.

A lithium secondary battery, an example of a secondary battery, has an advantage that energy density is higher and a capacity per unit area is larger than those of a Ni—Mg battery or a Ni—Cd battery. However, most of the electrolytes used in conventional lithium secondary batteries are liquid electrolytes, such as organic solvents. Accordingly, safety problems such as leakage of flammable electrolytes are constantly at issue.

To address this issue, interest in all-solid batteries using solid electrolytes rather than liquid electrolytes has recently increased. Since the liquid electrolyte is impregnated in the electrode of the lithium secondary battery using the liquid electrolyte, securing an ion conduction path in the electrode is relatively easy. On the other hand, in the case of an all-solid battery, a solid electrolyte needs to be added to the electrode itself in order to form the ion conduction path in the electrode. That is, the solid electrolyte is placed in a gap between the active material particles, so that ions may move smoothly in the electrode. If the gap between the active material particles constituting the electrode is large, the pores need to be filled with the solid electrolyte, so that an excessive amount of the solid electrolyte needs to be added to the electrode, thereby significantly reducing the energy density per volume and mass of the all-solid battery.

The above information disclosed in this Background section is only for enhancement of understanding of the background of the disclosure, and therefore it may contain information that does not form the related art.

### SUMMARY OF THE DISCLOSURE

The present disclosure has been made in an effort to solve the above-described problems associated with related art.

An object of the present disclosure is to provide an all-solid battery having high energy density per volume and mass.

Another object of the present disclosure is to provide an all-solid battery with an improved output due to a large contact area between an active material and a solid electrolyte.

The objects of the present disclosure are not limited to the objects described above. The objects of the present disclosure will be more apparent in the description below and implemented by means described in the claims and a combination thereof.

According to embodiments of the present disclosure, an electrode composition includes: at least two electrode active materials having different crushing strengths and particle sizes.

An electrode active material of the at least two electrode active materials may be selected from a group consisting of: a carbon-based active material, an oxide-based active material, a metal-based active material, and a combination thereof.

The at least two electrode active materials may include a first active material and a second active material, the first active material having a higher crushing strength than that of the second active material, and the first active material having a larger particle size than that of the second active material.

The first active material may have a crushing strength between 40 MPa and 1000 MPa.

The second active material may have a crushing strength between 0.1 MPa and 10 MPa.

The first active material may have a particle size between 10 μm and 20 μm.

The second active material may have a particle size between 1 μm and 5 μm.

The particle size of the first active material may be 2 to 20 times larger than the particle size of the second active material.

The at least two electrode active materials may include 70 wt % to 90 wt % of the first active material and 10 wt % to 30 wt % of the second active material.

The at least two electrode active materials may include the first active material and the second active material at a weight ratio between 7:1 and 5:1.

The electrode composition may further include a third active material which is selected from a group consisting of: a carbon-based active material, an oxide-based active material, a metal-based active material, and a combination thereof, the third active material having a lower crushing strength than that of the first active material and a higher crushing strength than that of the second active material, and the third active material having a smaller particle size than that of the first active material and a larger particle size than that of the second active material.

The third active material may have a crushing strength of more than 10 MPa and less than 40 MPa.

The third active material may have a particle size of more than 5 μm and less than 10 μm.

The at least two electrode active materials may include 60 wt % to 90 wt % of the first active material, 10 wt % to 20 wt % of the second active material, and 10 wt % to 20 wt % of the third active material.

The electrode composition may further include a solid electrolyte, a conductive material, and a binder.

The solid electrolyte may be coated on a surface of the at least two electrode active materials.

The solid electrolyte may be coated on the surface of the at least two electrode active materials with a thickness of 0.2 nm to 30 nm.

The electrode composition may include 50 wt % to 95 wt % of the at least two electrode active materials.

Furthermore, according to embodiments of the present disclosure, an electrode includes: at least two electrode active materials having different crushing strengths and particle sizes. The at least two electrode active materials include a first active material and a second active material, the first active material having a higher crushing strength than that of the second active material, and the first active material having a larger particle size than that of the second active material.

The electrode may have a structure in which space between particles of the first active material is filled with the second active material, the structure having a porosity of less than 5%.

Furthermore, according to embodiments of the present disclosure, a lithium secondary battery includes an anode that is an electrode including at least two electrode active materials having different crushing strengths and particle sizes. The at least two electrode active materials include a first active material and a second active material, the first active material having a higher crushing strength than that of the second active material, and the first active material having a larger particle size than that of the second active material.

The lithium secondary battery may be an all-solid battery.

According to embodiments of the present disclosure, when the electrode is formed using the electrode composition, it is possible to enhance energy density per volume and mass of the all-solid battery. When the electrode is formed using the electrode composition, it is possible to increase a contact area between the active material and the solid electrolyte and improve an output of the all-solid battery.

The effects of the present disclosure are not limited to the aforementioned effects. It should be understood that the effects of the present disclosure include all effects inferable from the description below.

Other aspects and preferred embodiments of the disclosure are discussed infra.

### BRIEF DESCRIPTION OF THE DRAWINGS

The above and other features of the present disclosure will now be described in detail with reference to certain embodiments thereof illustrated in the accompanying drawings which are given hereinbelow by way of illustration only, and thus are not limitative of the present disclosure, and wherein:

FIG. 1 illustrates a configuration of an electrode composition according to embodiments of the present disclosure;

FIG. 2 illustrates a configuration of an additional electrode composition according to embodiments of the present disclosure;

FIG. 3 schematically illustrates a solid electrolyte coated on the surface of a first active material of the present disclosure;

FIG. 4 schematically illustrates a solid electrolyte coated on the surface of a second active material of the present disclosure;

FIG. 5 schematically illustrates a solid electrolyte coated on the surface of a third active material of the present disclosure; and

FIG. 6 illustrates an electrode including the electrode composition and a lithium secondary battery including the electrode.

Reference numerals set forth in the Drawings includes reference to the following elements as further discussed below:

10: electrode active material
11: first active material
12: second active material
13: third active material
20: solid electrolyte
D1: particle size of first active material
D2: particle size of second active material
T1, T2: coating thickness of solid electrolyte
100: lithium secondary battery
110: anode
120: cathode
130: electrolyte

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment. In the figures, reference numbers refer to the same or equivalent parts of the present disclosure throughout the several figures of the drawing.

### DETAILED DESCRIPTION OF THE EMBODIMENTS

Hereinafter reference will now be made in detail to various embodiments of the present disclosure, examples of which are illustrated in the accompanying drawings and described below. While the disclosure will be described in conjunction with certain embodiments, it will be understood that present description is not intended to limit the disclosure to those embodiments. On the contrary, the disclosure is intended to cover not only the disclosed embodiments, but also various alternatives, modifications, equivalents and other embodiments, which may be included within the spirit and scope of the disclosure as defined by the appended claims.

The above objects, other objects, features, and advantages of the present disclosure will be easily understood through the following preferred exemplary embodiments with reference to the accompanying drawings. The present disclosure is not limited to the embodiments described therein and may also be modified in various different ways. On the contrary, embodiments introduced herein are provided to make disclosed contents thorough and complete and sufficiently transfer the spirit of the present disclosure to those skilled in the art.

In the description of each drawing, like reference numerals are used for like constitute elements. In the accompanying drawings, dimensions of structures are illustrated to be more enlarged than actual dimensions for clarity of the present disclosure. Terms such as first, second, and the like may be used to describe various components and the components should not be limited by the terms. The terms are used to only distinguish one component from another component. For example, a first component may be referred to as a second component, and similarly, the second component may be referred to as the first component without departing from the scope of the present disclosure. Singular expressions used herein include plurals expressions unless they have definitely opposite meanings in this context.

In the present application, it should be understood that the term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance. It will be understood that when an element such as a layer, film, region, or substrate is referred to as being “on” another element, it can be directly on the other element or intervening elements may also be present. On the contrary, it will be understood that when an element such as a layer, film, region, or substrate is referred to as being “below” another element, it can be directly below the other element or intervening elements may also be present.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Referring now to embodiments of the present disclosure, FIG. 1 schematically illustrates an electrode composition according to embodiments of the present disclosure.

As shown in FIG. 1, the electrode composition according to embodiments of the present disclosure includes at least two electrode active materials 10 having different crushing strength and particle sizes. The electrode active material 10 (which includes the at least two electrode active materials) may be selected from the group consisting of: a carbon-based active material, an oxide-based active material, a metal-based active material, and a combination thereof.

The carbon-based active material is not particularly limited as long as the carbon-based active material contains carbon and may be, for example, natural graphite, artificial graphite, graphite, hard carbon, soft carbon, and the like. The oxide-based active material may be, for example, Cu₂O, Y₂O₅, Co₃O₄, MnOₓ, SnOₓ, Fe₃O₄, Li₁Ti₅O₁₂, SiO, and the like. The metal-based active material may be a metal element such as germanium (Ge), indium (In), aluminum (Al), silicon (Si), tin (Sn), lithium (Li), sulfur (S), and the like or a compound containing the same.

The electrode active material 10 includes a first active material 11 and a second active material 12, and the first active material 11 has higher crushing strength and a larger particle size than the second active material 12.

As illustrated in FIG. 1, since the space between the particles of the first active material 11 having a large size is filled with the second active material 12 having a small size, the porosity in the electrode may be largely reduced when the electrode is formed of the electrode composition. Accordingly, the input amount of the solid electrolyte 20 for securing the ion conduction path in the electrode may be reduced, and a denser high-density electrode may be formed, thereby largely increasing the energy density per volume and mass of the battery.

Since the second active material 12 having low crushing strength is located between the first active materials 11 having high crushing strength when the electrode composition is coated on the substrate, dried and then pressurized to form the electrode, the contact areas between the first active materials 11, between the first active material 11 and the second active material 12, and between the second active materials 12 increase to be a good help in improvement of the battery output.

The first active material 11 may have a crushing strength of 40 MPa or more. When the crushing strength of the first active material 11 is less than 40 MPa, the shape thereof may not be maintained during pressure molding for forming the electrode, and thus, the structure of the electrode in which the gap between the first active material 11 particles is filled with the second active material 12 may not be formed. The upper limit of the crushing strength of the first active material 11 is not particularly limited, but for example, may be 1000 MPa.

The second active material 12 may have a crushing strength of 10 MPa or less. When the crushing strength of the second active material 12 is more than 10 MPa, the electrode may not be compressed during the pressure molding for forming the electrode, and thus a high-density electrode may not be implemented. The lower limit of the crushing strength of the second active material 12 is not particularly limited, but for example, may be 0.1 MPa.

The first active material 11 may have a particle size of 10 μm to 20 μm. When the particle size of the first active material 11 is less than 10 μm, it is difficult to reduce the porosity in combination with the second active material 12, and when the particle size is more than 20 μm, the volume density increases and thus, the electrode energy density may decrease.

The second active material 12 may have a particle size of 1 μm to 5 μm. If the particle size of the second active material 12 is less than 1 μm, it is difficult to handle the second active material 12 due to the too small size, and when the particle size thereof is more than 5 μm, the size thereof is larger than the gap between the particles of the first active material 11, and thus, the high-density electrode can not be implemented. Particularly, when the particle size of the first active material 11 is 2 to 20 times larger than the particle size of the second active material 12, the high-density electrode may be implemented.

The electrode active material may include 70 wt % to 90 wt % of the first active material 11 and 10 wt % to 30 wt % of the second active material 12. Only when the contents of the first active material 11 and the second active material 12 are within the above numerical ranges, the porosity may be reduced because the second active material 12 is not combined.

Particularly, the electrode active material may include the first active material 11 and the second active material 12 at a weight ratio of 7:1 to 5:1.

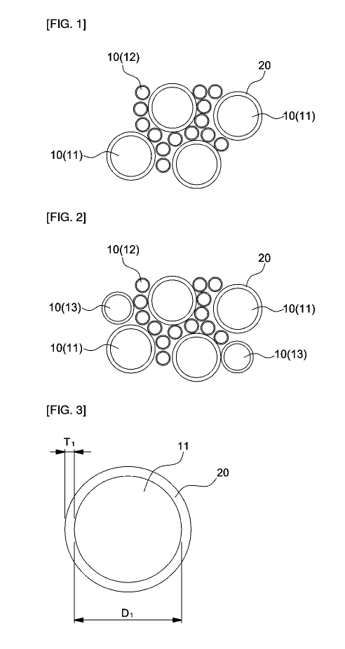

FIG. 2 briefly illustrates an additional electrode composition according to embodiments of the present disclosure.

As shown in FIG. 2, an electrode composition according to embodiments of the present disclosure further includes a third active material 13 in addition to the first active material 11 and the second active material 12 described above.

The third active material 13 has a lower crushing strength and a smaller particle size than the first active material 11 and has a higher crushing strength and a larger particle size than the second active material 12. Particularly, the third active material 13 may have a crushing strength of more than 10 MPa and less than 40 MPa, and a particle size of more than 5 μm and less than 10 μm.

The electrode composition may further include the third active material 13 having an intermediate property between the first active material 11 and the second active material 12, thereby widening the contact area between the electrode active materials and implementing a denser high density electrode.

The electrode active material may include 60 wt % to 90 wt % of the first active material 11, 10 wt % to 20 wt % of the second active material 12, and 10 wt % to 20 wt % of the third active material 13.

Referring to FIGS. 1 and 2, the electrode composition may further include a solid electrolyte 20.

The solid electrolyte 20 is not particularly limited as long as the solid electrolyte 20 is an ion conductive material used in the lithium secondary battery, and for example, the solid electrolyte 20 may be an oxide-based solid electrolyte, such as Li₃ₓLa_{2/3-x}TiO₃(LLTO) having a perovskite structure, Li₇La₃Zr₂O₁₂(LLZO) having a garnet structure, Li₁₊ₓAlₓTi₂₋ₓ(PO₄)₃(LATP) having a phosphate-based NASICON structure, and the like, and may be a sulfide-based solid electrolyte, such as Li₂S—P₂S₅, Li₂S—SiS₂, Li₂S—SiS₂—P₂S₅, Li₂S—GeS₂, and the like.

The solid electrolyte 20 may be applied in the form of powder or particles, but preferably, may be applied in the form of being coated on the surface of the electrode active material 10. The reason is that the input amount of the solid electrolyte 20 to secure the ion conduction path in the electrode may be further reduced.

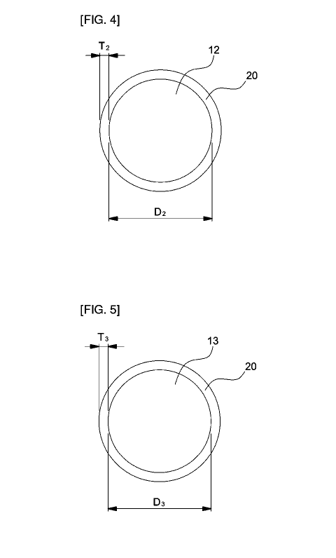

FIG. 3 schematically illustrates the solid electrolyte 20 coated on the surface of the first active material 11.

As shown in FIG. 3, the solid electrolyte 20 may be coated on the surface of the first active material 11 having a particle size D₁ of 10 μm to 20 μm with a thickness T₁ of 0.2 nm to 30 nm. When the thickness T₁ of the solid electrolyte 20 is less than 0.2 nm, the ion conduction path in the electrode may not be formed properly because the solid electrolyte 20 is damaged in the process of forming the electrode, and when the thickness T₁ is more than 30 nm, the reduction effect of the input amount of the solid electrolyte is slight, or the electrolyte may interfere with the electron conduction to cause deterioration of cell performance.

FIG. 4 schematically illustrates the solid electrolyte 20 coated on the surface of the second active material 12.

As shown in FIG. 4, the solid electrolyte 20 may be coated on the surface of the second active material 12 having a particle size D₂ of 1 μm to 5 μm with a thickness T₂ of 0.2 nm to 30 nm. When the thickness T₂ of the solid electrolyte 20 is less than 0.2 nm, the ion conduction path in the electrode may not be formed properly because the solid electrolyte 20 is damaged in the process of forming the electrode, and when the thickness T₂ is more than 30 nm, the reduction effect of the input amount of the solid electrolyte is slight, or the electrolyte may interfere with the electron conduction to cause deterioration of cell performance.

FIG. 5 schematically illustrates the solid electrolyte 20 coated on the surface of the third active material 13.

As shown in FIG. 5, the solid electrolyte 20 may be coated on the surface of the third active material 13 having a particle size D₃ of more than 5 μm and less than 10 μm with a thickness T₃ of 0.2 nm to 30 nm. When the thickness T₃ of the solid electrolyte 20 is less than 0.2 nm, the ion conduction path in the electrode may not be formed properly because the solid electrolyte 20 is damaged in the process of forming the electrode, and when the thickness T₃ is more than 30 nm, the reduction effect of the input amount of the solid electrolyte is slight, or the electrolyte may interfere with the electron conduction to cause deterioration of cell performance.

The electrode composition may further include a conductive material, a binder, and the like. The conductive material is not particularly limited as long as the conductive material is an electron conductive material, and may be, for example, graphite, carbon black, conductive fiber, or the like.

The binder is a configuration for maintaining adhesion between components of the electrode composition and is not particularly limited as long as the binder is a material capable of performing the above functions and for example, may include polyvinylidene fluoride (PVdF), polyvinyl alcohol, carboxymethylcellulose (CMC), starch, hydroxypropylcellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluorine rubber, and the like.

The electrode composition may include the electrode active material 10, the solid electrolyte 20, the conductive material, and the binder, and may include 50 wt % to 95 wt % of the electrode active material 10. When the content of the electrode active material 10 is less than 50 wt %, the improvement degree of the output may be slight and when the content thereof is more than 95 wt %, the content of the other components is too small and rather, ionic conductivity and/or the electrical conductivity may be significantly deteriorated.

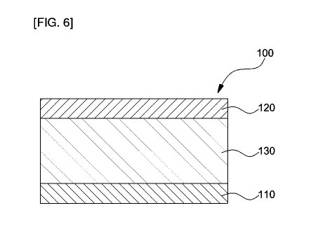

FIG. 6 illustrates an electrode including the electrode composition and a lithium secondary battery including the electrode.

As shown in FIG. 6, the lithium secondary battery 100 includes an anode 110 including the electrode composition, a cathode 120 facing the anode 110, and an electrolyte 130 interposed between the cathode 120 and the anode 110.

The lithium secondary battery 100 may be an all-solid battery in which the electrolyte 130 is a solid electrolyte.

The cathode 120 may include a cathode active material, a solid electrolyte, a conductive material, a binder, and the like. The cathode active material may be a compound containing sulfur (S) such as Li₂S or a transition metal oxide including a lithium element. The solid electrolyte, the conductive material and the binder may be the same as or different from the solid electrolyte, the conductive material and the binder included in the electrode composition.

The electrolyte 130 may be a liquid electrolyte, but is preferably a solid electrolyte. When the electrolyte 130 is formed of the solid electrolyte, the electrolyte 130 may be the same as or different from the solid electrolyte included in the electrode composition.

The anode 110 includes the electrode composition. The anode 110 may be formed by applying slurry obtained by dispersing the electrode composition in a solvent onto a substrate, drying, and then pressing. Accordingly, the anode may be a high-density electrode having a dense structure formed by filling a space (gap) between the particles of the first active material 11 with the second active material 12 and a porosity of less than about 5%.

According to the present disclosure, when the electrode is formed with the electrode composition including at least two electrode active materials having different crushing strength and particle sizes, the space between electrode active material particles having a large size is filled with an electrode active material having a small size, thereby greatly reducing the porosity of the electrode and implementing a high-density electrode having a dense structure. Accordingly, it is possible to obtain a lithium secondary battery having very high energy density per volume and mass.

According to the present disclosure, since the electrode is formed with the solid electrolyte coated on the surface of the electrode active material, the input amount of the solid electrolyte for securing the ion conduction path in the electrode may be greatly reduced, thereby further increasing the energy density per volume and mass of the lithium secondary battery.

The disclosure has been described in detail with reference to certain embodiments thereof. However, it will be appreciated by those skilled in the art that changes may be made in these embodiments without departing from the principles and spirit of the disclosure, the scope of which is defined in the appended claims and their equivalents.

What is claimed is:

1. An electrode composition, comprising:
at least two electrode active materials having different crushing strengths and particle sizes.

2. The electrode composition of claim 1, wherein an electrode active material of the at least two electrode active materials is selected from a group consisting of: a carbon-based active material, an oxide-based active material, a metal-based active material, and a combination thereof.

3. The electrode composition of claim 1, wherein the at least two electrode active materials include a first active material and a second active material, the first active material having a higher crushing strength than that of the second active material, and the first active material having a larger particle size than that of the second active material.

4. The electrode composition of claim 3, wherein the first active material has a crushing strength between 40 MPa and 1000 MPa.

5. The electrode composition of claim 3, wherein the second active material has a crushing strength between 0.1 MPa and 10 MPa.

6. The electrode composition of claim 3, wherein the first active material has a particle size between 10 μm and 20 μm.

7. The electrode composition of claim 3, wherein the second active material has a particle size between 1 μm and 5 μm.

8. The electrode composition of claim 3, wherein a particle size of the first active material is 2 to 20 times larger than a particle size of the second active material.

9. The electrode composition of claim 3, wherein the at least two electrode active materials include 70 wt % to 90 wt % of the first active material and 10 wt % to 30 wt % of the second active material.

10. The electrode composition of claim 3, wherein the at least two electrode active materials include the first active material and the second active material at a weight ratio between 7:1 and 5:1.

11. The electrode composition of claim 3, wherein the at least two electrode active materials further include a third active material which is selected from a group consisting of: a carbon-based active material, an oxide-based active material, a metal-based active material, and a combination thereof, the third active material having a lower crushing strength than that of the first active material and a higher crushing strength than that of the second active material, and the third active material having a smaller particle size than that of the first active material and a larger particle size than that of the second active material.

12. The electrode composition of claim 11, wherein the third active material has a crushing strength of more than 10 MPa and less than 40 MPa.

13. The electrode composition of claim 11, wherein the third active material has a particle size of more than 5 μm and less than 10 μm.

14. The electrode composition of claim 11, wherein the at least two electrode active materials include 60 wt % to 90 wt % of the first active material, 10 wt % to 20 wt % of the second active material, and 10 wt % to 20 wt % of the third active material.

15. The electrode composition of claim 3, further comprising:
a solid electrolyte;
a conductive material; and
a binder.

16. The electrode composition of claim 15, wherein the solid electrolyte is coated on a surface of the at least two electrode active materials.

17. The electrode composition of claim 16, wherein the solid electrolyte is coated on the surface of the at least two electrode active materials with a thickness of 0.2 nm to 30 nm.

18. The electrode composition of claim 15, wherein the electrode composition includes 50 wt % to 95 wt % of the at least two electrode active materials.

19. An electrode, comprising:
at least two electrode active materials having different crushing strengths and particle sizes,
wherein the at least two electrode active materials include a first active material and a second active material, the first active material having a higher crushing strength than that of the second active material, and the first active material having a larger particle size than that of the second active material.

20. The electrode of claim 19, wherein the electrode has a structure in which space between particles of the first active material is filled with the second active material, the structure having a porosity of less than 5%.

21. A lithium secondary battery, comprising:
an anode,
wherein the anode is an electrode including at least two electrode active materials having different crushing strengths and particle sizes, and
wherein the at least two electrode active materials include a first active material and a second active material, the first active material having a higher crushing strength than that of the second active material, and the first active material having a larger particle size than that of the second active material.

22. The lithium secondary battery of claim 21, wherein the lithium secondary battery is an all-solid battery.
